(19) United States
(12) Patent Application Publication
(10) Pub. No.: US 2009/0181713 A1
(43) Pub. Date: Jul. 16, 2009

(54) METHOD AND APPARATUS FOR CONTROLLING POWER SOURCE OF TERMINAL DEVICE FOR COMMUNICATING WITH WIRELESS WIDE AREA NETWORK

(75) Inventors: Hak-goo LEE, Suwon-si (KR); Ji-sang Kim, Yongin-si (KR); Jong-ho Park, Suwon-si (KR); Jin-min Kim, Seoul (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/252,730

(22) Filed: Oct. 16, 2008

(30) Foreign Application Priority Data
Jan. 15, 2008 (KR) 2008-4429

(51) Int. Cl. H04B 7/00

(52) U.S. Cl. 455/522; 455/70; 370/311

(57) ABSTRACT

A method of controlling a power source of a terminal device for communicating with a wireless wide area network, the method including: receiving a data packet; determines whether only some components of the terminal device are to be used to process the received data packet or whether an entirety of the terminal device is to be used to process the received data packet; and based on the determination result, waking up the some components of the terminal device or the entirety of the terminal device from a sleep mode to an awake mode so as to process the received data packet.

### CROSS-REFERENCE TO RELATED APPLICATION

This application claims the benefit of Korean Patent Application No. 2008-4429, filed Jan. 15, 2008 in the Korean Intellectual Property Office, the disclosure of which is incorporated herein by reference.

### BACKGROUND OF THE INVENTION

1. Field of the Invention

Aspects of the present invention relate to a method and apparatus to control a power source, and more particularly, to a method and apparatus to control a power source of a terminal device for communicating with a wireless wide area network.

2. Description of the Related Art

Recently, wireless wide area network technologies based on the Internet (such as Wireless Broadband (WiBro)) have been developed. FIG. 1 is a diagram illustrating a conventional wireless wide area network. Referring to FIG. 1, in the conventional wireless wide area network, a broadcast packet, from among Transmission Control Protocol/Internet Protocol (TCP/IP) packets transmitted via the Internet 110, is filtered in a base station 120. Thus, the broadcast packet is not transferred to a terminal device 130. On the other hand, a unicast packet is transferred to the terminal device 130 (for example, a portable terminal device) such that when the unicast packet is transferred to the terminal device 130, the entire terminal device 130 is woken up from a sleep mode to an awake mode. Here, the awake mode is a state in which a power source is supplied to the terminal device 130. To wake up the terminal device 130 is an operation by which the power source is supplied to the terminal device 130 so as to switch a mode from the sleep mode to the awake mode.

However, such a conventional wireless wide area network wakes up the entire terminal device 130 although only some components of the terminal device 130 are to be used, and thus the terminal device 130 unnecessarily consumes power. Also, the conventional wireless wide area network wakes up the entire terminal device 130 when operations that do not require a user confirmation are performed, thereby causing inconvenience to a user since the user has to unnecessarily check the terminal device 130.

### SUMMARY OF THE INVENTION

Aspects of the present invention provide a method and apparatus to control a power source of a terminal device for communicating with a wireless wide area network, thereby preventing an unnecessary power consumption by the terminal device and providing a user with more enhanced convenience in terms of the usage of the terminal device.

According to an aspect of the present invention, there is provided a method of controlling a power source of a terminal device for communicating with a wireless wide area network, the method including: receiving a data packet; determining whether only a first set of components of the terminal device, less than all components of the terminal device, is to be used to process the received data packet or whether an entirety of the terminal device is to be used to process the received data packet; and waking up the first set of components of the terminal device or the entirety of the terminal device from a sleep mode to an awake mode so as to process the received data packet, based on a result of the determining.

The method may further include the receiving an interrupt signal to instruct a wake-up of the terminal device; determining whether the received interrupt signal is a signal to wake up a second set of components of the terminal device, less than all components of the terminal device, or is a signal to wake up the entirety of the terminal device; and waking up the second set of components of the terminal device or the entirety of the terminal device, based on a result of the determining for the received interrupt signal, wherein the receiving of the data packet is performed when only the second set of components of the terminal device is woken up.

The second set of components of the terminal device may include a central processing unit (CPU) of the terminal device and a receiving unit of the terminal device, such that the receiving unit receives the interrupt signal and the data packet.

The waking up may include waking up the first set of components of the terminal device or the entirety of the terminal device by additionally waking up other components, from among the first set of components of the terminal device or the entirety of the terminal, that are not included in the second set of components.

The determining may include, when an application of the terminal device is used to process the received data packet, determining that the entirety of the terminal device is used to process the received data packet.

The determining may include, when the received data packet is an Internet Control Message Protocol (ICMP) packet, a Transmission Control Protocol (TCP) Timeout packet, an Address Resolution Protocol (ARP) packet, and/or a Reversed Address Resolution Protocol (RARP) packet, determining that only the first set of components of the terminal device are to be used to process the received data packet.

The determining may include, when the interrupt signal is a signal generated by a user via a power supply command for the terminal device, or is an alarm signal using a real-time clock (RTC), determining that the interrupt signal is a signal for waking up the entirety of the terminal device.

The method may further include decreasing a clock rate of a CPU in the terminal device to a low clock rate when the first set of components and/or the second set of components of the terminal device are woken up; and increasing the clock rate of the CPU in the terminal device to a high clock rate when the entirety of the terminal device is woken up.

According to another aspect of the present invention, there is provided an apparatus to control a power source of a terminal device for communicating with a wireless wide area network, the apparatus including: a receiving unit to receive a data packet; a first determination unit to determine whether only a first set of components of the terminal device, less than all components of the terminal device, is used to process the received data packet or whether an entirety of the terminal device is used to process the received data packet; and a first wake-up unit to wake up the first set of components of the terminal device or the entirety of the terminal device from a sleep mode to an awake mode so as to process the received data packet, based on a determination result of the first determination unit.

The power source control apparatus of claim may further include a second determination unit to determine whether the received interrupt signal is a signal to wake up a second set of components of the terminal device, less than all components of the terminal device, or is a signal to wake up the entirety of the terminal device when the receiving unit receives an interrupt signal to instruct a wake-up of the terminal device; and a second wake-up unit to wake up the second set of components of the terminal device or the entirety of the terminal device, based on a determination result of the second determination unit, wherein the receiving unit receives the data packet when the second set of components of the terminal device are woken up.

According to another aspect of the present invention, there is provided a computer readable recording medium having recorded thereon a program to execute a method of controlling a power source of a terminal device for communicating with a wireless wide area network, the method including: receiving a data packet; determining whether only a first set of components of the terminal device, less than all components of the terminal device, is to be used to process the received data packet or whether an entirety of the terminal device is to be used to process the received data packet; and waking up the first set of components of the terminal device or the entirety of the terminal device from a sleep mode to an awake mode so as to process the received data packet, based on a result of the determining.

According to yet another aspect of the present invention, there is provided a method of controlling a power source of a terminal device for communicating with a wireless wide area network, the method including: receiving an interrupt signal to instruct a wake-up of the terminal device; determining whether the received interrupt signal is a signal to wake up a first set of components of the terminal device, less than all components of the terminal device, or is a signal to wake up an entirety of the terminal device; waking up the first set of components of the terminal device or the entirety of the terminal device, based on a result of the determining for the received interrupt signal; receiving a data packet; if the received interrupt signal is determined to be the signal to wake up the first set of components, determining whether only a second set of components of the terminal device, less than all components of the terminal device, is to be used to process the received data packet or whether the entirety of the terminal device is to be used to process the received data packet; and waking up the second set of components of the terminal device or the entirety of the terminal device from a sleep mode to an awake mode so as to process the received data packet, based on a result of the determining for the data packet.

According to still another aspect of the present invention, there is provided a method of controlling a power source of a terminal device for communicating with a wireless wide area network, the method including: determining whether a set of components of the terminal device, less than all components of the terminal device, are to be used to perform a desired operation or whether an entirety of the terminal device is to be used to perform the desired operation; and waking up the set of components of the terminal device or the entirety of the terminal device from a sleep mode to an awake mode so as to perform the desired operation, based on a result of the determining.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram illustrating a conventional wireless wide area network;

FIG. 2 is a flowchart of a method of controlling a power source of a terminal device for communicating with a wireless wide area network, according to an embodiment of the present invention;

FIG. 3 is a flowchart of a method of controlling a power source of a terminal device for communicating with a wireless wide area network, according to another embodiment of the present invention;

FIG. 4 is a block diagram of an apparatus to control a power source of a terminal device for communicating with a wireless wide area network, according to an embodiment of the present invention; and

FIG. 5 is a block diagram describing a method of controlling a power source of a terminal device for communicating with a wireless wide area network, according to an embodiment of the present invention.

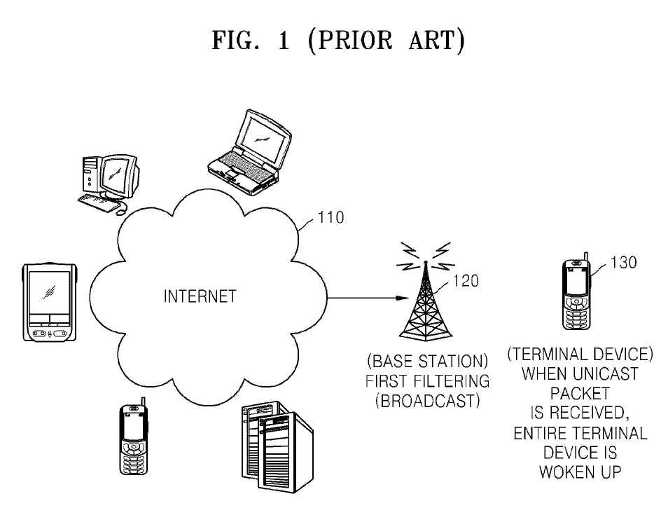

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

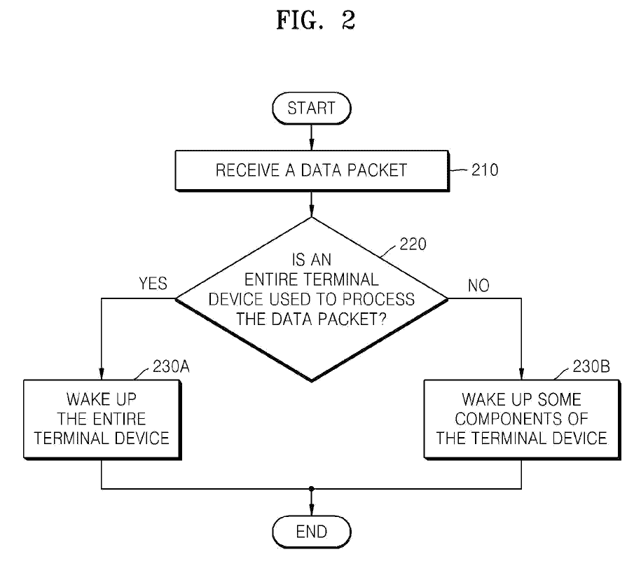

FIG. 2 is a flowchart of a method of controlling a power source of a terminal device for communicating with a wireless wide area network, according to an embodiment of the present invention. Referring to FIG. 2, a data packet is received in operation 210. Here, the data packet may be a unicast packet including audio data, video data, text data, and/or image data. Also, the data packet may be an Internet Control Message Protocol (ICMP) packet, a Transmission Control Protocol (TCP) Timeout packet, an Address Resolution Protocol (ARP) packet, and/or a Reversed Address Resolution Protocol (RARP) packet. Here, the ICMP packet is a protocol packet for a connectionless transmission, and is assembled with an Internet protocol (IP) in an Internet communication service based on TCP/IP so as to deal with an error that may occur during a communication and to process a control message for changing a transmission path. The TCP Timeout packet is a TCP packet that is received again by the terminal device that has received the TCP packet, has entered to a sleep mode thereafter, and is then woken up. Also, the ARP packet is a protocol packet that is used to match an IP address in an IP network to a physical network address. Inversely, the RARP packet is a protocol packet that is used to change a hardware address to the IP address.

In operation 220, it is determined whether only some devices (i.e., components) included in the terminal device are used to process the received data packet or whether the entire terminal device is used to process the received data packet. For example, in the case where an application of the terminal device is used to process the received data packet, it may be determined that the entire terminal device is used to process the received data packet. Also, in the case where the received data packet is the ICMP packet, the TCP Timeout packet, the ARP packet, and/or the RARP packet, it may be determined that only some of the components included in the terminal device are used to process the received data packet.

When it is determined that the entire terminal device is used to process the received data packet (operation 220), the entire terminal device is woken up from a sleep mode to an awake mode so as to process the received data packet in operation 230A. At this time, as described above, when the application of the terminal device is used to process the received data packet, the entire terminal device may be woken up so as to be in the awake mode. Also, according to aspects of the present invention, a central processing unit (CPU) of the terminal device may be operated at a high clock rate when the entire terminal device is woken up.

If it is otherwise determined that only some components included in the terminal device are used to process the received data packet (operation 220), only those components used to process the received data packet are woken up so as to process the received data packet in operation 230B. For example, when the terminal device operates as a file transfer protocol (FTP) server, the terminal device is used only to transmit data to a user. Thus, a display unit of the terminal device does not have to be woken up, and only the CPU, a synchronous dynamic random access memory (SDRAM), a modem, and a storage unit of the terminal device may be woken up. Also, according to aspects of the present invention, the CPU of the terminal device may be operated at a low clock rate when only some components of the terminal device are woken up.

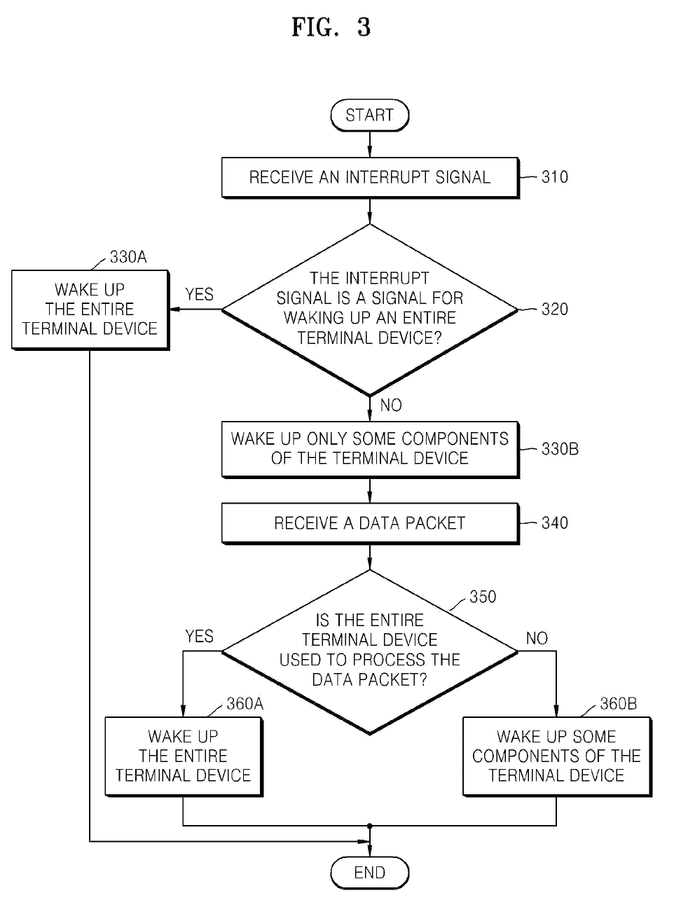

FIG. 3 is a flowchart of a method of controlling a power source of a terminal device for communicating with a wireless wide area network, according to another embodiment of the present invention. Referring to FIG. 3, an interrupt signal to instruct a wake-up of the terminal device is received in operation 310.

Then, it is determined whether the received interrupt signal (operation 310) is a signal to wake up some components of the terminal device, or is a signal to wake up the entire terminal device in operation 320.

If it is determined that the received interrupt signal is to wake up the entire terminal device (operation 320), the entire terminal device is woken up in operation 330A. For example, the entire terminal device may be woken up when the received interrupt signal is generated by a user via a power supply command for the terminal device, or when the received interrupt signal is an alarm signal using a real-time clock (RTC). The interrupt signal generated by the power supply command may be generated when the user presses a power button of the terminal device. Also, the alarm signal using the RTC is a signal that commands a power source to be supplied to a computer at a predetermined time.

If it is otherwise determined that the received interrupt signal is the signal for waking some of the components of the terminal device (operation 320), those components included in the terminal device are woken up in operation 330B. For example, only a CPU and a modem of the terminal device may be woken up so as to communicate with an external device. However, it is understood that other components, in addition to or instead of the CPU and the modem, may be woken up. Also, according to aspects of the present invention, the CPU of the terminal device may be operated at a low clock rate when only some components of the terminal device are woken up.

A data packet is received in operation 340. At this time, according to aspects of the present invention, the terminal device may receive the data packet such that only the CPU and the modem are woken up.

It is then determined whether only some components included in the terminal device are used to process the received data packet, or whether the entire terminal device is used to process the received data packet.

When it is determined that the entire terminal device is used to process the received data packet (operation 350), the entire terminal device is woken up from a sleep mode to an awake mode so as to process the received data packet in operation 360A. In this manner, when the entire terminal device is woken up (operation 360A), the entire terminal device may be woken up by waking up the components that were not woken up in operation 330B as well as the components that were woken up in operation 330B.

If it is determined that only some components included in the terminal device are used to process the received data packet (operation 350), only those components used to process the received data packet are woken up so as to process the received data packet in operation 360B. At this time, in the case where some components of the terminal device that are to be woken up are the same as those components that were woken up in operation 330B, the other components that were not woken up in operation 330B are not additionally woken up. However, in the case where other components that were not woken up in operation 330B, as well as those components that were woken up in operation 330B, are to be woken up so as to process the received data packet, the other components that were not woken up in operation 330B are woken up in operation 360B.

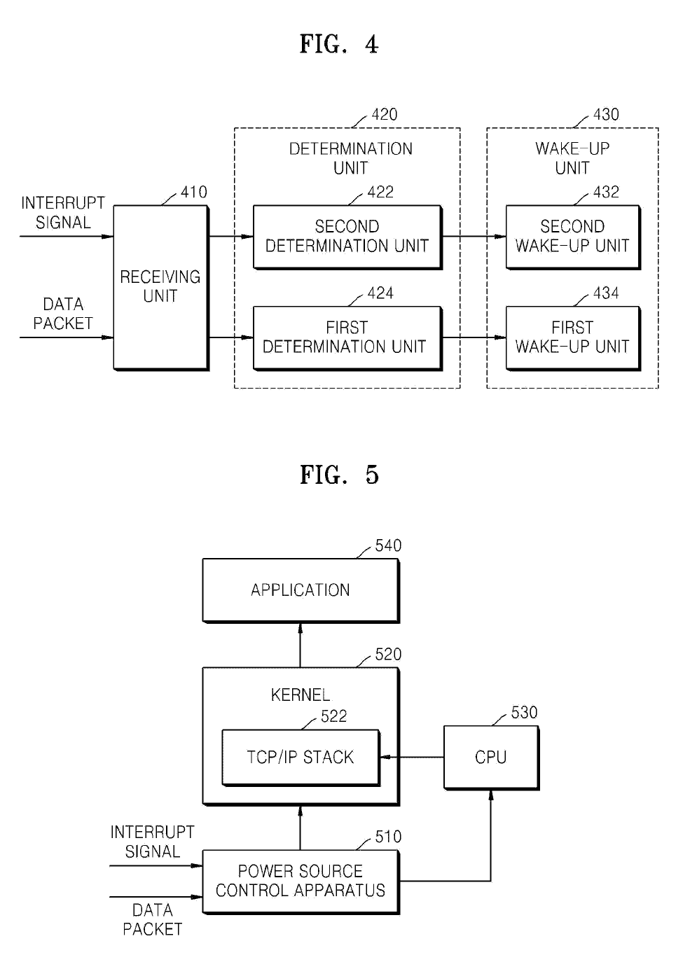

FIG. 4 is a block diagram of an apparatus to control a power source of a terminal device for communicating with a wireless wide area network (hereinafter, referred to as “a power source control apparatus”), according to an embodiment of the present invention.

Referring to FIG. 4, the apparatus to control a power source includes a receiving unit 410, a determination unit 420, and a wake-up unit 430.

The receiving unit 410 receives an interrupt signal or a data packet. For example, the receiving unit 410 may be a modem of the terminal device.

The determination unit 420 includes a second determination unit 422 and a first determination unit 424. Accordingly, when the receiving unit 410 receives the interrupt signal to instruct a wake-up of the terminal device, the second determination unit 422 determines whether the received interrupt signal is a signal to wake up some components of the terminal device, or is a signal to wake up the entire terminal device. The first determination unit 424 determines whether some of the components included in the terminal device are used to process the received data packet, or whether the entire terminal device is used to process the received data packet.

The wake-up unit 430 includes a second wake-up unit 432 and a first wake-up unit 434. The second wake-up unit 432 wakes up some of the components of the terminal device or the entire terminal device, based on the determination result of the second determination unit 422. Similarly, the first wake-up unit 434 wakes up some of the components of the terminal device or the entire terminal device from a sleep mode to an awake mode so as to process the received data packet, based on the determination result of the first determination unit 424.

FIG. 5 is a block diagram describing a method of controlling a power source of a terminal device for communicating with a wireless wide area network, according to an embodiment of the present invention. Referring to FIG. 5, the terminal device includes a power source control apparatus 510, a kernel 520, a CPU 530, and an application 540. Also, from among the components of the kernel 520, only a TCP/IP stack 522 is illustrated for convenience of description, though it is understood that the kernel 520 may include other and/or additional components. Here, when the power source control apparatus 510 receives a data packet, the TCP/IP stack 522 processes the received data packet according to a control of the CPU 530. Otherwise, the TCP/IP stack 522 may transmit the data packet to the application 540, thereby enabling the application 540 to process the data packet.

First, when a receiving unit of the power source control apparatus 510 receives an interrupt signal, a determination unit of the power source control apparatus 510 determines whether the interrupt signal is a signal to wake up some components of the terminal device, or is a signal to wake up the entire terminal device. A wake-up unit of the power source control apparatus 510 wakes up some of the components of the terminal device or the entire terminal device, based on a determination result of the determination unit. For example, when the interrupt signal is the signal to wake up the kernel 520 and the CPU 530, the wake-up unit of the power source control apparatus 510 wakes up the kernel 520 and the CPU 530 without waking up the entire terminal device. At the same time, the TCP/IP stack 522 included in the kernel 520 is also woken up. Meanwhile, in the case where the TCP/IP stack 522 is not embodied as software but is embodied as hardware, the TCP/IP stack 522 may directly transmit data to the application 540, without being under the control of the CPU 530. In this case, the wake-up unit of the power source control apparatus 510 may only wake up the TCP/IP stack 522 that is embodied as hardware, but may not wake up the CPU 530.

Next, when the receiving unit of the power source control apparatus 510 receives a data packet, while the kernel 520 and the CPU 530 of the terminal device are woken up, the determination unit of the power source control apparatus 510 determines whether some of the components included in the terminal device are used to process the received data packet, or whether the entire terminal device is used to process the received data packet. Based on a determination result of the determination unit, the wake-up unit of the power source control apparatus 510 wakes up some of the components of the terminal device, or the entire terminal device, so as to process the received data packet. For example, in the case where the received data packet may be processed by using only the kernel 520 and the CPU 530, the application 540 is not required to be woken up. Thus, the wake-up unit of the power source control apparatus 510 wakes up the kernel 520 and the CPU 530 without waking up the application 540. However, in the case where the application 540 is used to process the received data packet, the application 540 receives the data packet from the TCP/IP stack 522 according to a control of the CPU 530 so as to process the data packet. Thus, the wake-up unit of the power source control apparatus 510 wakes up all of the kernel 520, the CPU 530, and the application 540. At this time, according to aspects of the present invention, it is understood that other included units of the terminal device, such as a display unit, may be woken up in addition to the application 540.

As described above, aspects of the present invention prevent unnecessary power consumption by a terminal device and provide a user with more enhanced convenience when the user uses the terminal device.

Furthermore, aspects of the present invention can be written as computer programs and can be implemented in general-use digital computers that execute the programs using a computer readable recording medium. Examples of the computer readable recording medium include magnetic storage media (e.g., ROM, floppy disks, hard disks, etc.), and optical recording media (e.g., CD-ROMs, or DVDs). Aspects of the present invention may also be realized as a data signal embodied in a carrier wave and comprising a program readable by a computer and transmittable over the Internet.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of controlling a power source of a terminal device for communicating with a wireless wide area network, the method comprising:
receiving a data packet;
determining whether only some of a first set of components of the terminal device, less than all components of the terminal device, is to be used to process the received data packet or whether an entirety of the terminal device is to be used to process the received data packet; and
waking up the first set of components of the terminal device or the entirety of the terminal device from a sleep mode to an awake mode so as to process the received data packet, based on a result of the determining.

2. The method as claimed in claim 1, further comprising:
receiving an interrupt signal to instruct a wake-up of the terminal device;
determining whether the received interrupt signal is a signal to wake up a second set of components of the terminal device, less than all components of the terminal device, or is a signal to wake up the entirety of the terminal device; and
waking up the second set of components of the terminal device or the entirety of the terminal device, based on a result of the determining for the received interrupt signal.

3. The method as claimed in claim 2, wherein the receiving of the data packet comprises receiving the data packet if the second set of components of the terminal device are woken up based on the result of the determining for the received interrupt signal.

4. The method as claimed in claim 2, wherein the second set of components of the terminal device include a central processing unit (CPU) of the terminal device and a receiving unit of the terminal device used to receive the interrupt signal and/or the data packet.

5. The method as claimed in claim 3, wherein the waking up to process the received data packet comprises:
waking up the first set of components of the terminal device by additionally waking up some of the first set of components that are not included in the second set of components; and
waking up the entirety of the terminal device by additionally waking up other components of the entirety of the terminal device that are not included in the second set of components.

6. The method as claimed in claim 1, wherein the determining for the data packet comprises determining that the entirety of the terminal device is used to process the received data packet when an application of the terminal device is used to process the received data packet.

7. The method as claimed in claim 1, wherein the determining for the data packet comprises determining that only the first set of components of the terminal device are used to process the received data packet when the received data packet is an Internet Control Message Protocol (ICMP) packet, a Transmission Control Protocol (TCP) Timeout packet, an Address Resolution Protocol (ARP) packet, and/or a Reversed Address Resolution Protocol (RARP) packet.

8. The method as claimed in claim 2, wherein the determining for the received interrupt signal comprises determining that the interrupt signal is the signal to wake up the entirety of the terminal device when the interrupt signal is a signal generated by a user via a power supply command for the terminal device, or is an alarm signal using a real-time clock (RTC).

9. The method as claimed in claim 2, further comprising:
setting a clock rate of a CPU in the terminal device to a first clock rate when at least one of the first set of components and the second set of components of the terminal device are woken up; and
setting the clock rate of the CPU in the terminal device to a second clock rate when the entirety of the terminal device is woken up,
wherein the second clock rate is greater than the first clock rate.

10. An apparatus to control a power source of a terminal device for communicating with a wireless wide area network, the apparatus comprising:
a receiving unit to receive a data packet;
a first determination unit to determine whether only a first set of components of the terminal device, less than all components of the terminal device, is to be used to process the received data packet or whether an entirety of the terminal device is to be used to process the received data packet; and
a first wake-up unit to wake up the first set of components of the terminal device or the entirety of the terminal device from a sleep mode to an awake mode so as to process the received data packet, based on a determination result of the first determination unit.

11. The apparatus as claimed in claim 10, further comprising:
a second determination unit to determine whether a received interrupt signal is a signal to wake up a second set of components of the terminal device, less than all components of the terminal device, or is a signal to wake up the entirety of the terminal device when the receiving unit receives the interrupt signal to instruct a wake-up of the terminal device; and
a second wake-up unit to wake up the second set of components of the terminal device or the entirety of the terminal device, based on a determination result of the second determination unit.

12. The apparatus as claimed in claim 11, wherein the receiving unit receives the data packet if the second set of components of the terminal device is woken up based on the determination result of the second determination unit.

13. The apparatus as claimed in claim 11, wherein the second set of components of the terminal device includes a central processing unit (CPU) of the terminal device and the receiving unit.

14. The apparatus as claimed in claim 12, wherein the first wake-up unit wakes up the first set of components of the terminal device by additionally waking up some of the first set of components that are not included in the second set of components, and wakes up the entirety of the terminal device by additionally waking up other components of the entirety of the terminal device that are not included in the second set of components.

15. The apparatus as claimed in claim 10, wherein the first determination unit determines that the entirety of the terminal device is used to process the received data packet when an application of the terminal device is used to process the received data packet.

16. The apparatus as claimed in claim 10, wherein the first determination unit determines that only the first set of components of the terminal device is used to process the received data packet when the received data packet is an Internet Control Message Protocol (ICMP) packet, a Transmission Control Protocol (TCP) Timeout packet, an Address Resolution Protocol (ARP) packet, and/or a Reversed Address Resolution Protocol (RARP) packet.

17. The apparatus as claimed in claim 11, wherein the second determination unit determines that the interrupt signal is the signal to wake up the entirety of the terminal device when the interrupt signal is a signal generated by a user via a power supply command for the terminal device, or is an alarm signal using a real-time clock (RTC).

18. The apparatus as claimed in claim 11, wherein the first and/or the second wake-up units set a clock rate of a CPU in the terminal device to a first clock rate when at least one of the first set of components and the second set of components of the terminal device are woken up, and sets the clock rate of the CPU in the terminal device to a second clock rate, greater than the first clock rate, when the entirety of the terminal device is woken up.

19. A computer readable recording medium having recorded thereon a program for executing the method of claim 1 and implemented by one or more computers.

20. A method of controlling a power source of a terminal device for communicating with a wireless wide area network, the method comprising:
determining whether a set of components of the terminal device, less than all components of the terminal device, are to be used to perform a desired operation or whether an entirety of the terminal device is to be used to perform the desired operation; and
waking up the set of components of the terminal device or the entirety of the terminal device from a sleep mode to an awake mode so as to perform the desired operation, based on a result of the determining.

21. The method as claimed in claim 20, wherein the desired operation is a communication operation on the wireless wide area network.

22. A computer readable recording medium having recorded thereon a program for executing the method of claim 20 and implemented by one or more computers.
